(19) United States
(12) Patent Application Publication
(10) Pub. No.: US 2018/0370459 A1
(43) Pub. Date: Dec. 27, 2018

(54) APPARATUS AND METHOD FOR CHECKING OR MONITORING IN-VEHICLE CONTROL UNIT

(71) Applicants: HYUNDAI MOTOR COMPANY, SEOUL (KR); KIA MOTORS CORPORATON, SEOUL (KR)

(72) Inventor: Seung Yong KWAK, Anyang-si (KR)

(73) Assignees: HYUNDAI MOTOR COMPANY, SEOUL (KR); KIA MOTORS CORPORATON, SEOUL (KR)

(21) Appl. No.: 15/822,950

(22) Filed: Nov. 27, 2017

(30) Foreign Application Priority Data
Jun. 22, 2017 (KR) 10-2017-0079070

(51) Int. Cl. B60R 16/023; G07C 5/00; G08C 17/00; G07C 5/08

(52) U.S. Cl. CPC B60R 16/023; G07C 5/0808; G08C 17/00; G07C 5/008

(57) ABSTRACT

The present disclosure provides an apparatus for inspecting an electronic control module of a vehicle. The apparatus includes a plurality of electronic control modules configured to control a device or system embedded in the vehicle, and a Controller Area Network (CAN) configured to interconnect the plurality of electronic control modules, wherein a CAN inspection message is configured to check operation states of the plurality of electronic control modules.

### CROSS-REFERENCE TO RELATED APPLICATION

The present application claims priority to and the benefit of Korean Patent Application No. 10-2017-0079070, filed on Jun. 22, 2017, which is incorporated by reference in its entirety.

### FIELD

The present disclosure relates to an apparatus and method for diagnosing a state of a vehicle control unit or monitoring operations of the vehicle control unit, and more particularly to a method and apparatus for more efficiently diagnosing states of electric and electronic control devices.

### BACKGROUND

The statements in this section merely provide background information related to the present disclosure and may not constitute prior art.

With rapid development of vehicle technology, a vehicle may include various electronic control units (or modules), and the electronic control units may control various devices or systems embedded in the vehicle. For example, the electronic control units may include an engine control module (ECM), a transmission control unit (TCU), an airbag control unit (ACU), an antilock braking system (ABS), an instrument and driver information module (IDIM), and the like.

The electronic control units may be connected to one another over a vehicle communication network (e.g., a Controller Area Network (CAN)). Upon receiving various control input signals and operation parameters through the vehicle communication network, the electronic control units may control a device or system, the engine control module (ECM), for example. In order to control the engine's ignition and fuel system, the electronic control units may receive information regarding depressed accelerator pedal as an input signal. In order to enhance engine performance, the ECM may monitor an engine speed, torque, and other operation parameters. Some control or operation parameters monitored by one module may be requested by at least one of other modules. For example, the engine speed monitored by the ECM may be requested by the transmission control unit (TCU), a brake release module, and instruments and driver information module (INST). For traction control purposes, wheel speed monitored by the ABS may also be used by the ECM and the TCU.

Various modules may be interconnected through a vehicle communication network (e.g., a CAN) so that information may be communicated between the modules and the modules may perform their functions in an integrated manner. The CAN which is being used as a vehicle communication network may connect the plurality of electronic control modules with one another, and may be an example of a vehicle network having high stability and reliability that can be used for a long period of time. If it is possible to monitor faults or operation states of the plurality of electronic control modules embedded in the vehicle using the CAN communication, vehicle driving stability can be improved and maintenance and management of the vehicle can be more efficiently achieved.

### SUMMARY

The present disclosure provides an apparatus and method for diagnosing faults of a vehicle control unit or monitoring operations of the vehicle control unit, which can quickly detect operation states or diagnose faults of a plurality of electronic control modules embedded in a vehicle using a single message over a CAN which acts as a vehicle communication network in the vehicle.

The present disclosure also provides an apparatus and method for diagnosing faults of a vehicle control unit or monitoring operations of the vehicle control unit, which can quickly recognize operation states and fault diagnosis of the electronic control modules embedded in the vehicle. It can also determine not only the presence or absence of autonomous driving of the vehicle but also vehicle driving safety according to the operational state and fault diagnosis result.

Moreover, the present disclosure provides an apparatus and method which can easily recognize the operational state and fault diagnosis result of the electronic control modules embedded in the vehicle in terms of maintenance and management of the vehicle, thereby improving mobility of the vehicle.

Additional features of the disclosure will be set forth in part in the description which follows and in part will become apparent to those having ordinary skill in the art upon examination of the following or may be learned from practice of the disclosure. Other advantages of the disclosure may be realized and attained by the structure particularly pointed out in the written description and claims hereof as well as the appended drawings.

In one form of the present disclosure, an apparatus for inspecting an electronic control module of a vehicle includes: a plurality of electronic control modules configured to control a device or system embedded in the vehicle; and a Controller Area Network (CAN) configured to interconnect the plurality of electronic control modules, wherein a CAN inspection message is configured to check operation states of the plurality of electronic control modules.

Each electronic control module of the plurality of electronic control modules may have an independent identifier (ID) or address, and may correspond to a bit contained in the CAN inspection message.

The plurality of electronic control modules may be configured to sequentially transmit and receive the CAN inspection message within a predetermined amount of time.

When a first electronic control module of the plurality of electronic control modules transmits the CAN inspection message to a second electronic control module of the plurality of electronic control modules within a predetermined amount of time, the second electronic control module of the plurality of electronic control modules may be configured to update a target address contained in the CAN inspection message to a third electronic control module of the plurality of electronic control modules.

When the first electronic control module of the plurality of electronic control modules does not transmit the CAN inspection message to the second electronic control module of the plurality of electronic control modules within the predetermined amount of time, but the first electronic control module of the plurality of electronic control modules transmits the CAN inspection message to the third electronic control module of the plurality of electronic control modules, the third electronic control module of the plurality of electronic control modules may be configured to display a fault-state of the second electronic control module of the plurality of electronic control modules that is contained in the CAN inspection message corresponding to the second electronic control module of the plurality of electronic control modules, and may update the target address to a fourth electronic control module of the plurality of electronic control modules.

The predetermined amount of time may be 10 ms. An amount of time needed to inspect the operation states of the plurality of electronic control modules may be substantially identical to an amount of time that is obtained by multiplying a number of the electronic control modules of the plurality of electronic control modules by the predetermined time of 10 ms.

The plurality of electronic control modules may include at least one sub-group, and each sub-group of the at least one sub-group include eight (8) electronic control modules or less.

The CAN inspection message may have a data length of eight (8) bytes, wherein a first byte among the 8 bytes may indicate the electronic control module, and a second byte to an eighth byte among the 8 bytes may indicate a sub-group of the at least one sub-group.

Each bit contained in the second byte to the eighth byte may correspond to an electronic control module that is contained in each sub-group, and the CAN inspection message may be displayed in hexadecimal.

The CAN inspection message may be include identifier (ID) information that is based on a standard format or an extended format.

When the CAN inspection message checks the operation states of the electronic control modules that are contained in some parts of the sub-groups, the some parts of the sub-groups may be designated through the ID information.

The apparatus may further include: an On Board Diagnostics (OBD) terminal configured to transmit the CAN inspection message to the plurality of electronic control modules, and output to an external part the CAN inspection message including information regarding the operation states of the plurality of electronic control modules.

The apparatus may further include: a self-diagnosis device embedded in the vehicle, configured to transmit and receive the CAN inspection message; and a communication device configured to transmit the information regarding the operation states of the plurality of electronic control modules that are detected by the self-diagnosis device.

In another aspect of the present disclosure, a method for inspecting an electronic control module of a vehicle for use in an inspection apparatus, the method includes: providing a CAN inspection message for checking operation states of a plurality of electronic control modules; recording information regarding the operation states of the plurality of electronic control modules in the CAN inspection message; and checking the operation states of the plurality of electronic control modules through the CAN inspection message. Here, the CAN is configured to interconnect the plurality of electronic control modules such that the plurality of electronic control modules control a device or system embedded in the vehicle.

Each electronic control module of the plurality of electronic control modules may have an independent identifier (ID) or address, and may correspond to a bit contained in the CAN inspection message.

The electronic control modules of the plurality of electronic control modules may be configured to sequentially transmit and receive the CAN inspection message within a predetermined amount of time.

When a first electronic control module of the plurality of electronic control modules transmits the CAN inspection message to a second electronic control module of the plurality of electronic control modules within a predetermined amount of time, updating, with the second electronic control module of the plurality of electronic control modules, a target address contained in the CAN inspection message to a third electronic control module of the plurality of electronic control modules. When the first electronic control module of the plurality of electronic control modules does not transmit the CAN inspection message to the second electronic control module of the plurality of electronic control modules within the predetermined amount of time but the first electronic control module of the plurality of electronic control modules transmits the CAN inspection message to the third electronic control module of the plurality of electronic control modules, displaying, with the third electronic control module of the plurality of electronic control modules, a fault-state of the second electronic control module of the plurality of electronic control modules that is contained in the CAN inspection message corresponding to the second electronic control module, and updating the target address to a fourth electronic control module of the plurality of electronic control modules.

The CAN inspection message may have a data length of eight (8) bytes, wherein a first byte among the 8 bytes may indicate the electronic control module, and a second byte to an eighth byte among the 8 bytes may indicate a sub-group.

The CAN inspection message may include identifier (ID) information that is based on a standard format or an extended format.

The single CAN inspection message may be transmitted through an On Board Diagnostics (OBD) terminal, and the CAN inspection message including information regarding the operation states of the plurality of electronic control modules may be output through the OBD terminal.

In accordance with another aspect of the present disclosure, the present disclosure may provide a computer-readable recording medium having recorded thereon an application program for performing the above method for inspecting electronic control modules for a vehicle, after being executed by a processor.

In accordance with another aspect of the present disclosure, an apparatus for inspecting a vehicle includes: a collection unit configured to collect information of the vehicle through a cable connected to an On Board Diagnostics (OBD) terminal embedded in the vehicle and to transmit and receive a CAN inspection message such that the CAN inspection message checks the operation states of the plurality of electronic control modules; and a processor configured to check operation states of a plurality of electronic control modules such that the plurality of electronic control modules control a device or system embedded in the vehicle, wherein the CAN is configured to interconnect the plurality of electronic control modules.

The plurality of electronic control modules may include at least one sub-group, and each sub-group of the at least one sub-group includes 8 electronic control modules or less.

The CAN inspection message may have a data length of 8 bytes, wherein a first byte among the 8 bytes may indicate the electronic control module, and a second byte to an eighth byte among the 8 bytes may indicate a sub-group of the at least one sub-group.

Each bit contained in the second byte to the eighth byte may correspond to an electronic control module that is contained in each sub-group, and the CAN inspection message may be displayed in hexadecimal.

The CAN inspection message may include identifier (ID) information that is based on a standard format or an extended format.

In accordance with another aspect of the present disclosure, an electronic control module embedded in a vehicle may have a processing system including at least one memory device storing at least one processor and a computer program so as to control a device or system embedded in the vehicle. The processing system include: upon receiving an inspection message through a Controller Area Network (CAN), receiving the inspection message during an allocated time; comparing a target address of the inspection message with an allocated address; recording information regarding the presence or absence of a fault of the electronic control module having a previous address in response to the confirmed target address; and transmitting the inspection message having the changed target address.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a vehicle including a plurality of electronic control modules;

FIG. 2 is a block diagram illustrating a vehicle diagnosis device;

FIG. 3 is a flowchart illustrating a method for diagnosing operation states or faults of the plurality of electronic control modules;

FIG. 4 is a block diagram illustrating an interconnection structure of the plurality of electronic control modules embedded in the vehicle;

FIG. 5 is a flowchart illustrating a self-diagnosis process of the electronic control modules;

FIG. 6 is a conceptual diagram illustrating a fault record (FR) message; and

FIG. 7 is a conceptual diagram illustrating an example for diagnosing the plurality of electronic control modules embedded in the vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, an apparatus and method in some forms of the present disclosure will be described with reference to the accompanying drawings. In the following description, suffixes “module” and “unit” contained in terms of constituent elements to be described will be selected or used together in consideration only of the convenience of writing the following specification, and the suffixes “module” and “unit” do not necessarily have distinct meanings or roles.

In the following description, assuming that a certain object is formed above (over) or below (beneath) the respective constituent elements, this means that two constituent elements are brought into direct contact with each other, one or more constituent elements are disposed and formed between two constituent elements. In addition, assuming that a certain object is formed over or below the respective constituent elements, this means that the object may also be arranged in upward or downward directions on the basis of the position of one constituent element.

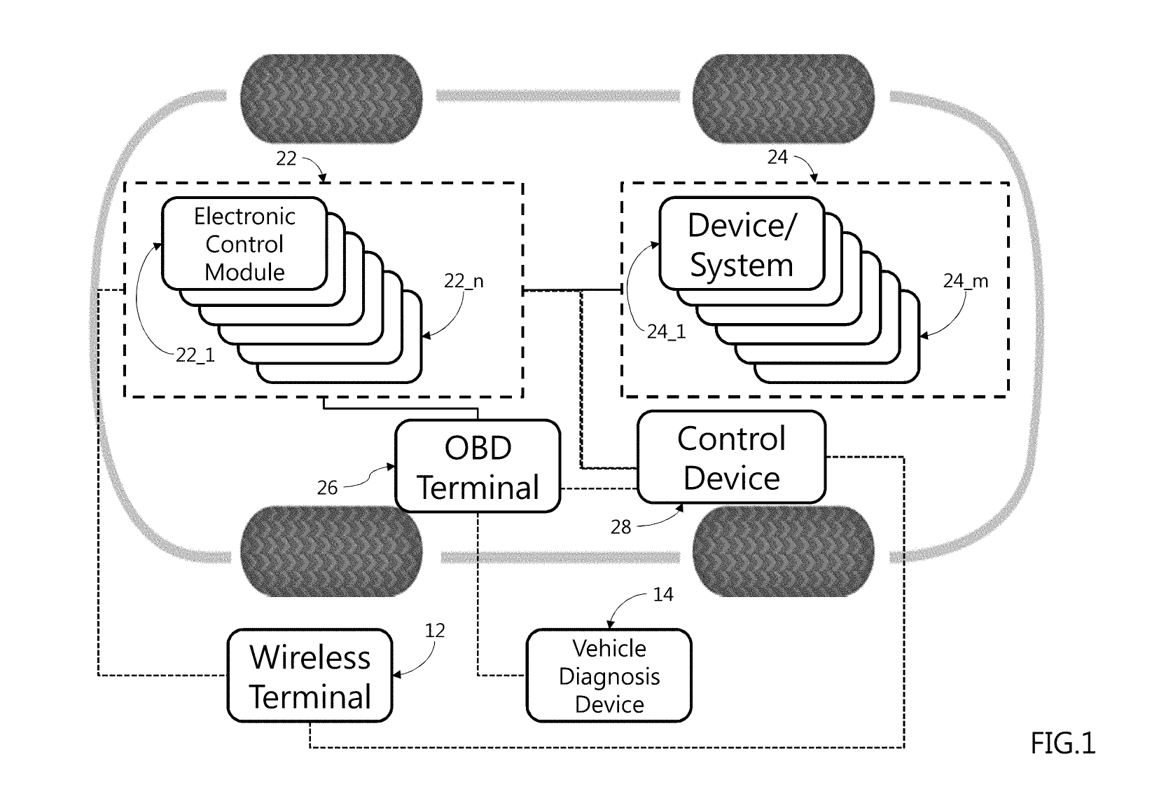

FIG. 1 is a block diagram illustrating a vehicle including a plurality of electronic control modules in some forms of the present disclosure.

Referring to FIG. 1, the vehicle may include a plurality of electronic control modules 22 and a plurality of devices or systems 24. The electronic control modules 22 may control the plurality of devices or systems 24 embedded in the vehicle. For example, the vehicle may include an engine acting as one of the plurality of devices or systems 24. As one of the plurality of electronic control modules 22, the vehicle may include an engine control module (ECM) for controlling the engine. As the vehicle is used not only as a simple transportation means, but also as other means, the number of devices or systems embedded in the vehicle is increasing, and the number of electronic control modules capable of controlling the devices or systems embedded in the vehicle is also increasing.

The plurality of electronic control modules 22 may include N electronic control modules 22_1 to 22_n (where N is a natural number), and the plurality of devices or systems 24 may include M devices or systems 24_1 to 24_m (where M is a natural number). In this case, the number of electronic control modules contained in the plurality of electronic control modules 22 may be identical to or different from the number of devices or systems contained in the system 24.

The plurality of electronic control modules 22 and the plurality of devices or systems 24 may be interconnected through the vehicle communication network. As a representative example of the vehicle communication network, a Controller Area Network (CAN) may be used. The CAN may be a communication scheme of a serial communication network devised for the vehicle network, and may support not only P2P (Point to Point) communication but also Multi-Master communication. That is, a plurality of constituent elements mounted to the vehicle, i.e., the plurality of electronic control modules 22 and the plurality of devices or systems 24, may be connected to one another according to the Multi-Master communication scheme, such that line costs having already been increased in proportion to the number of electronic control modules 22 and the number of devices or systems 24, line complexity, line space, and weight of lines can be reduced.

The CAN may connect various kinds of electronic control modules in parallel to one another using two lines, such that information may be interchanged between the electronic control modules according to priority information of the electronic control modules, all messages transmitted from all devices connected to the network may be confirmed, and it is determined whether or not the corresponding message will be filtered out. CAN communication may perform electrical differential communication using one pair of twisted lines, such that the CAN communication has high robustness against electrical noise. Although a maximum number of nodes is changed according to a CAN transceiver, it should be noted that a plurality of nodes ranging from tens of nodes to hundreds of nodes may also be connected to only one bus line. In addition, CAN controllers may support multi-master communication by which all (at least two) devices can act as a master, and a CAN communication speed may be a very high speed of about 1M bps.

In order to diagnose the operation state or the presence or absence of a fault of the electronic control modules 22 capable of being interconnected through the CAN, only one CAN message may be used. After only one CAN message is supplied to the CAN, each of the electronic control modules 22 may receive the CAN message to be supplied through the CAN at a unique time allocated thereto or at a predetermined time allocated thereto, may record the result regarding the presence or absence of a fault, and may then transmit the CAN message to the CAN. Assuming that each of the electronic control modules 22_1 to 22_n receives only one CAN message during a predetermined time allocated thereto, records the result regarding the presence or absence of a fault, and transmits the recorded result, after lapse of a predetermined time obtained when the number of the electronic control modules 22_1 to 22_n contained in the vehicle is multiplied by a time allocated to each of the electronic control modules 22_1 to 22_n, it is possible to confirm the operation states or faults of all electronic control modules 22_1 to 22_n contained in the vehicle through only one CAN message.

The respective electronic control modules 22 (including 22_1 to 22_n) embedded in the vehicle may have independent identifiers (IDs) or addresses. If the electronic control modules are connected to only one bus line, the electronic control modules 22 are connected to a master mode in which messages of connected bus lines are read and written. Therefore, in order to transmit a certain message to a specific electronic control module instead of all the electronic control modules, the respective electronic control modules need to be distinguished from one another using independent IDs or addresses allocated thereto. For example, the electronic control modules 22 (22_1˜22_n) may respectively correspond to bits contained in a data filed of a CAN inspection message.

In addition, the electronic control modules 22 (22_1˜22_n) may sequentially transmit and receive a single CAN inspection message within a predetermined time. For example, if a transmission/reception time of the CAN inspection message is set to 10 ms, the electronic control modules 22 (22_1˜22_n) may receive a message from the CAN, may update contents of the received message, and may retransmit the updated message to the CAN within the transmission/reception time of 10 ms.

If a specific process such as a diagnosis mechanism is performed, a time through which data can be communicated through the CAN may be allocated to the respective electronic control modules 22 (22_1˜22_n). For example, if the diagnosis mechanism for checking the operation states and faults of the plurality of electronic control modules 22 (22_1˜22_n) embedded in the vehicle is performed, after lapse of a predetermined time from a specific time point at which the diagnosis mechanism is performed by IDs or addresses allocated to the respective electronic control modules 22 (22_1˜22_n), a CAN message provided for the diagnosis mechanism may be received and transmitted during a time period allocated to the respective electronic control modules 22. That is, if the diagnosis mechanism is performed, a first electronic control module may receive and transmit the CAN message during 10 ms ranging from the beginning of the diagnosis mechanism, and a second electronic control module may receive and transmit the CAN message during a predetermined time of 10 ms to 20 ms ranging from the beginning of the diagnosis mechanism.

Meanwhile, the vehicle may include an On Board Diagnostics (OBD) terminal 26. The OBD may be a diagnosis/monitoring system capable of monitoring the plurality of electronic control modules 22 and the plurality of devices or systems 24 embedded in the vehicle. For example, if a fault may occur in the device or system embedded in the vehicle, a fault content may be stored in a vehicle control device 28 and the fault content may be transmitted through the OBD terminal 26 acting as a standardized connector. The user or driver may monitor and check operations of the plurality of electronic control modules 22 and the plurality of devices or systems 24 embedded in the vehicle through the OBD terminal 26. If a user or driver visits an auto mechanic or the like, the OBD terminal 26 may be connected to a vehicle diagnosis device 14, a computing device, or the like, such that information may be transmitted to the plurality of electronic control modules 22 and the plurality of devices or systems 24 embedded in the vehicle.

The control device 28 embedded in the vehicle may be included in the plurality of electronic control modules 22 or may be independently arranged. In this case, the control device 28 may store status information of the plurality of electronic control modules 22. In addition, even when the vehicle diagnosis device 14 is not connected through the OBD terminal 26, the control device may periodically or intermittently detect and store status information of the plurality of electronic control modules 22 embedded in the vehicle. For example, when power is supplied to the plurality of electronic control modules 22 embedded in the vehicle, the control device 28 may collect status information of the plurality of electronic control modules 22.

The vehicle may include a communication module (not shown) capable of being connected to the computing devices such as a wireless terminal 12 or a telematics server TMS (not shown) over a wireless communication network. The communication module may be included in the plurality of electronic control modules 22. The communication module may establish a wireless communication channel through which the plurality of electronic control modules 22 or the control device 28 can interact with the computing devices over the wireless communication network.

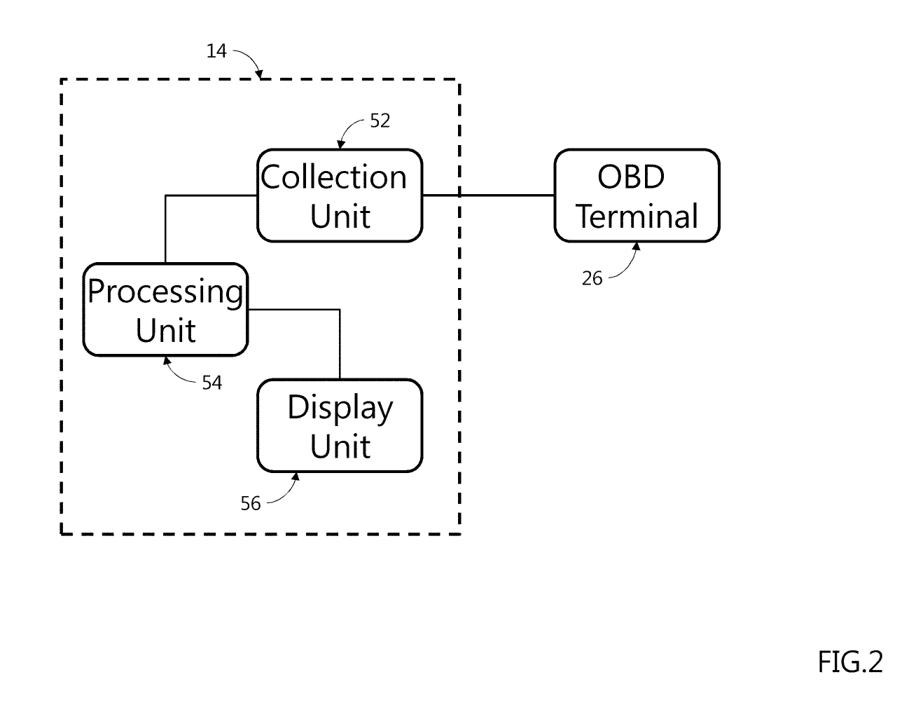

FIG. 2 is a block diagram illustrating a vehicle diagnosis device.

Referring to FIG. 2, the vehicle diagnosis device 14 may include a collection unit 52 configured to collect vehicle information through a cable connected to the OBD terminal 26 contained in the vehicle; and a processing unit 54 configured to check the operation states or faults of the plurality of electronic control modules 22 (see FIG. 1) connected through the CAN so as to control the devices or systems embedded in the vehicle (hereinafter referred to as “in-vehicle devices or systems”) through the information collected by the collection unit 52. The operation states or faults of the plurality of electronic control modules 22 embedded in the vehicle may be confirmed through a single CAN inspection message capable of being communicated through the collection unit 52.

The vehicle diagnosis device 14 may further include a display unit 56 capable of displaying the operation states or faults of the plurality of electronic control modules 22 recognized or detected by the processing unit 54. The display unit 56 may include a screen, a lamp, or the like capable of displaying the operation states or faults of the plurality of electronic control modules 22.

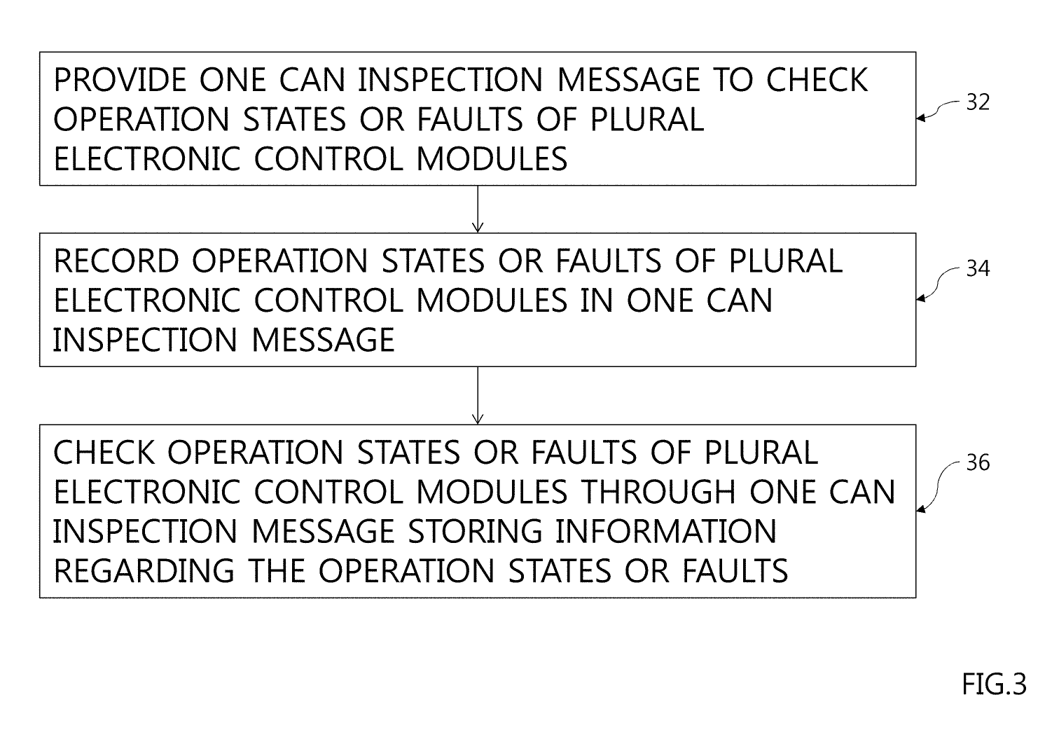

FIG. 3 is a flowchart illustrating a method for diagnosing operation states or faults of the plurality of electronic control modules.

Referring to FIG. 3, the method for inspecting the electronic control modules for the vehicle may be implemented in the vehicle in which the plurality of electronic control modules (see FIG. 1) for controlling in-vehicle devices or systems 24 (see FIG. 1) are interconnected through the CAN, or may be applied to an inspection device interacting with the vehicle.

A method for inspecting the vehicle electronic control modules may include a step 32 for providing a single CAN inspection message for checking the operation states or faults of the plurality of electronic control modules 22, a step 34 for recording the operation states or faults in the single CAN inspection message, and a step 36 for checking the operation states or faults of the plurality of electronic control modules 22 through the single CAN inspection message storing information regarding the operation states or faults.

The respective electronic control modules 22 (22_1˜22_n) embedded in the vehicle may include independent IDs or addresses. The respective electronic control modules 22 (22_1˜22_n) may correspond to respective bits contained in a data field of the CAN inspection message to be described later.

If the respective electronic control modules 22 (22_1˜22_n) are normally operated, the single CAN inspection message may be sequentially transmitted within a predetermined time. For example, when the CAN inspection message is normally transmitted from a first electronic control module to a second electronic control module within the predetermined time, the second electronic control module may update a target address contained in the CAN inspection message to a third electronic control module from among the plurality of electronic control modules. Here, the first electronic control module and the second electronic control module may be contained in the plurality of electronic control modules 22. The CAN inspection message received from the first electronic control module is not transmitted to the second electronic control module within the predetermined time and is then transmitted to the third electronic control module, the third electronic control module may display a faulty state of the second electronic control module in the data bit contained in the CAN inspection message corresponding to the second electronic control module, and may update the target address to the fourth electronic control module.

The CAN inspection message may be identified through identifier (ID) information used in a standard format or an extended format. For example, the standard format ID information may be composed of 11 bits, and may allocate a specific ID such as ‘400’ to the inspection message. Other messages transmitted through the CAN may be distinguished from the inspection message through specific ID information. Meanwhile, if it is difficult to perform allocation of the standard format message due to various kinds of CAN inspection messages, an extended format CAN message including ID information composed of 29 bits may be used.

In addition, each of the CAN inspection message based on the standard format and the CAN inspection message based on the extended format may have the data length of 8 bytes (64 bits). From among 8 bytes contained in a data region of the CAN inspection message, the first byte may be used as a target region indicating each electronic control module, and the second to eighth bytes from among the 8 bytes may respectively correspond to the plurality of electronic control modules 22 (22_1˜22_n).

If the vehicle diagnosis device 14 is connected to the outside of the vehicle, the single CAN inspection message may be transmitted through the OBD terminal 26. The single CAN inspection message including information regarding the operation states or faults of the respective electronic control modules 22 (22_1˜22_n) may be output through the OBD terminal 26.

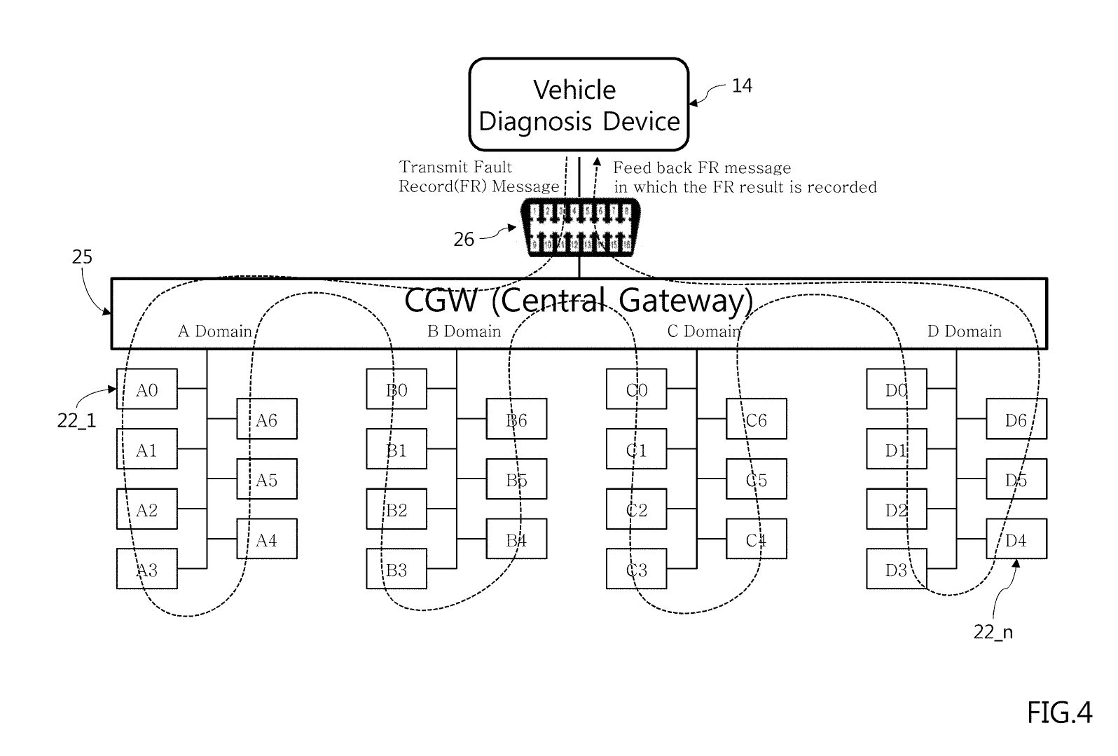

FIG. 4 is a block diagram illustrating an interconnection structure of the plurality of electronic control modules embedded in the vehicle.

Referring to FIG. 4, the plurality of electronic control modules 22 (see FIG. 1) capable of being connected to the vehicle diagnosis device 14 through the OBD terminal 26 may include a central gateway (CGW) 25 connected to the OBD terminal 26 and the electronic control modules 22_1˜22_n connected to the CGW 25 through a CAN bus.

In this case, the electronic control modules 22_1˜22_n may be distinguished or split from one another by at least one sub-group (e.g., at least one domain), and each sub-group (each domain) may include 8 electronic control modules or less. For example, the domain A may include 8 electronic control modules respective having IDs A0˜A7. The electronic control modules 22_1˜22_n may be distinguished by domains or sub-groups according to functions of the respective modules, for example, according to in-vehicle devices or systems 24 (see FIG. 1) capable of being controlled. In this case, the sub-groups or domains may correspond to logical concepts (relationship) or IDs. That is, electronic control modules (e.g., A0 and B3) contained in different domains (A domain and B domain) may be substantially connected in parallel to one bus line.

The reason why the respective electronic control modules (22_1˜22_n) are distinguished by sub-groups or domains is to respectively match bits contained in the data field of the CAN inspection message to the electronic control modules 22 (22_1˜22_n). In the CAN inspection message having the data length of 8 bytes (64 bits), the first byte from among the 8 bytes may be used as an address region indicating an electronic control module to be used as a destination of the message, and the second to eighth bytes from among the 8 bytes may indicate sub-groups. For example, the number of sub-groups may be 7, and 8 electronic control modules may be contained in each sub-group. Therefore, a total number of electronic control modules capable of checking the operation states or the presence or absence of a fault through a single CAN inspection message may be 56.

In some forms of the present disclosure, the number of electronic control modules embedded in the vehicle may be higher than 56. In this case, ID information contained in the CAN inspection message is distinguished such that a maximum of 56 CAN inspection messages can be provided. For example, if the number of electronic control modules embedded in the vehicle is 100, the operation states or faults of 50 electronic control modules can be checked through the CAN inspection message having the ID ‘400’, and the operation states or faults of 50 other electronic control modules through the CAN inspection message having the ID ‘401’.

Meanwhile, respective bits contained in the second to eighth bytes of the data region of the CAN inspection message may correspond to the electronic control modules contained in each sub-group, and the data region of the CAN inspection message may be displayed in hexadecimal.

The vehicle diagnosis device 14 may transmit a fault record (FR) message through the OBD terminal 26. The FR message may be transmitted to the electronic control modules 22_1˜22_n after passing through the OBD terminal 26 and the CGW 25. Each of the electronic control modules 22_1˜22_n may read the FR message during a predetermined time allocated thereto, and may record information regarding the presence or absence of a fault. After the electronic control modules 22_1˜22_n sequentially read the FR message in the arrow direction and record the fault-associated information, the read and record results may be fed back to the vehicle diagnosis device 14 through the CGW 25 and the OBD terminal 26.

In this case, the order of transferring the FR message by the electronic control modules 22_1˜22_n may be changed. For example, the electronic control modules 22_1˜22_n may transfer the FR message in the direction from the A domain to the D domain, and may also transfer the FR message in the direction from the D domain to the A domain. The electronic control modules 22_1˜22_n may transmit the FR message according to a predetermined algorithm or rule. However, the FR message received from the vehicle diagnosis device 14 may be designed to be fed back to the vehicle diagnosis device 14 after passing through all the electronic control modules 22_1˜22_n.

As described above, all the electronic control modules 22_1˜22_n may be connected in parallel to one bus line. The operation for transmitting the FR message using the electronic control modules 22_1˜22_n may be needed to determine the next reception electronic control module from among all the electronic control modules 22_1˜22_n connected in parallel to one another.

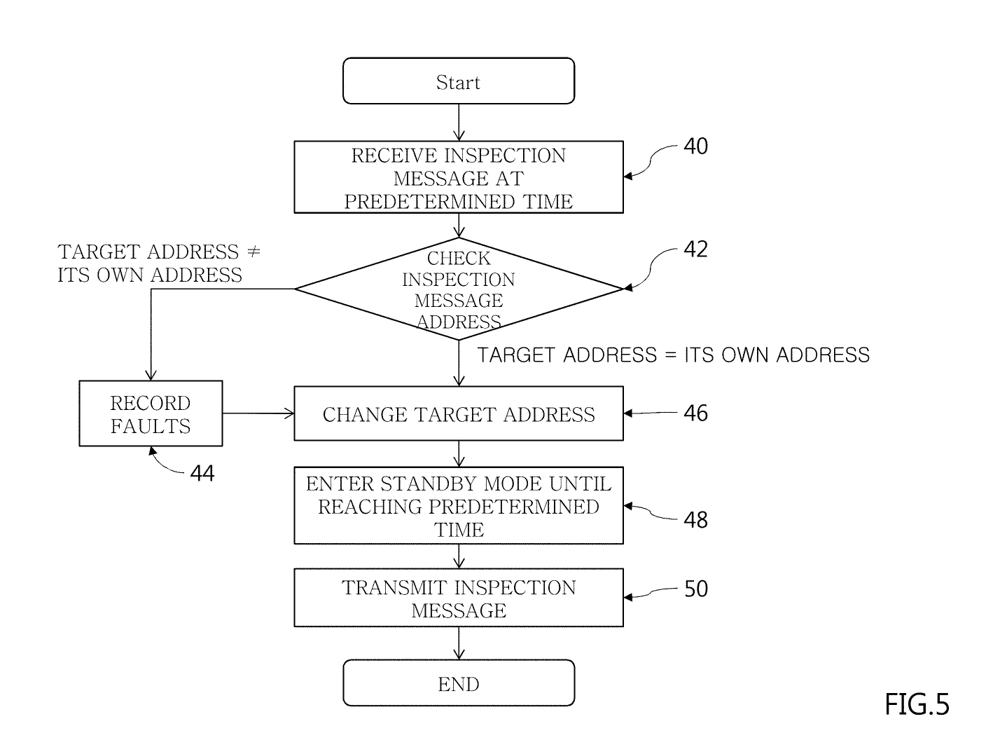

FIG. 5 is a flowchart illustrating a self-diagnosis process of the electronic control modules.

Referring to FIG. 5, the electronic control modules 22_1˜22_n (See FIG. 1) embedded in the vehicle may perform a unified self-diagnosis process. In addition, the electronic control modules 22_1˜22_n configured to perform the self-diagnosis process may include a processing system having at least one memory device that stores at least one processor and a computer program to control the in-vehicle devices or systems. The processing system contained in the electronic control modules may include receiving an inspection message during an allocated time upon receiving the inspection message through the CAN; comparing a target address of the received inspection message with an allocated address; recording the presence or absence of a fault of the electronic control module having a previous address in response to a confirmed target address; changing a target address to a next address; and transmitting an inspection message having the changed target address.

For example, the electronic control module may receive the inspection message during either a time allocated thereto or a predetermined time (40). In this case, the allocated time or the predetermined time may be changed according to an in-vehicle communication network or an inspection mechanism. For example, if the inspection mechanism is performed, a time period ranging from a start time to the predetermined time may be allocated to one electronic control module scheduled to first receive the inspection message, and the other electronic control module scheduled to secondly receive the inspection message may be allocated a time period ranging from a subsequent time located after the start time to the predetermined time.

Each of the electronic control modules may receive the inspection message transmitted through the CAN bus line at a specific time allocated thereto (40). Each electronic control module may determine whether an address or ID written in the target address region of the inspection message is identical to an address or ID allocated thereto (42). For example, it is assumed that the electronic control module having the address A3 (see FIG. 4) has updated the target address region to the address A4. After the electronic control module having the address A4 confirms the target address region after receiving the corresponding inspection message, the electronic control module may recognize that a value allocated to the target address region is identical to its own address. In this case, it can be recognized that there is no fault between two electronic control modules respectively having the address A3 and the address A4.

Thereafter, the electronic control modules may change the target address region of the inspection message (46). For example, the electronic control module having the address A4 may update the target address region to the address A5.

Thereafter, each of the electronic control modules may enter a maintenance and standby mode during a time allocated thereto or a predetermined time (48). Before the time allocated to the electronic control module is ended, the electronic control module may transmit the inspection message in which the target address is changed to the CAN bus line (50).

Meanwhile, the electronic control module may continuously transmit the inspection message in which the target address is changed to the CAN bus line, instead of entering the maintenance and standby mode during the time allocated to the electronic control module itself or the predetermined time.

When the electronic control module determines whether the address or ID written in the target address region of the inspection message is identical to its own address or ID (42), the determination result may indicate that a value of the target address region contained in the inspection message may be different from the address value of the electronic control module. In this case, the electronic control module may record fault information in the data region in the inspection message (44), and may change the value of the target address region (46).

For example, it is assumed that the electronic control module having the address B1 changes the value of the target address region and then transmits the changed value. Thereafter, the electronic control module having the address B2 has to receive the corresponding message at a time allocated thereto or at a predetermined time. Here, an unexpected problem may occur in the electronic control module having the address B2. In this case, the electronic control module having the address B2 at a corresponding time may not receive the inspection message. After lapse of the predetermined time, the electronic control module having the address B3 may receive the inspection message from the CAN bus line at a time allocated thereto or at a predetermined time. Under this situation, the electronic control module having the address B3 may recognize that the address B2 of the target address region contained in the received inspection message is different from its own address B3. In addition, the electronic control module having the address B3 may recognize a faulty state of the electronic control module. Therefore, the electronic control module having the address B3 may change a value of the bit corresponding to the other electronic control module having the address B2 in the data region of the inspection message (e.g., the bit value of 0→the bit value of 1). When the electronic control module having the address B1 changes the value of the target address region contained in the inspection message to the other address B2 and then transmits the resultant target address region having the address B2, it can be assumed that all the electronic control modules respectively having B2, B3, and B4 addresses do not receive the inspection message, and the electronic control module having the address B4 then receives the corresponding inspection message after lapse of a predetermined time. In this case, the electronic control module having the address B5 may recognize faulty states of all the electronic control modules (i.e., the electronic control modules respectively having B2, B3 and B4 addresses) ranging from the electronic control module having the target address region value B2 to other electronic control modules having previous addresses. The electronic control module having the address B5 may change the values of the bits corresponding to the electronic control modules having B2, B3 and B4 addresses contained in the data region of the inspection message.

If it is determined that no faulty state occurs in the electronic control modules, i.e., if the CAN inspection message is normally transmitted from the first electronic control module to the second electronic control module from among the plurality of electronic control modules, the second electronic control module may update the target address contained in the CAN inspection message to the third electronic control module selected from among the plurality of electronic control modules.

In contrast, if a faulty state of the electronic control module is determined, i.e., if the CAN inspection message received from the first electronic control module is not transmitted to the second electronic control module within the predetermined time and is transmitted to the third electronic control module, the third electronic control module may display a faulty state of the second electronic control module in the data bit of the CAN inspection message corresponding to the second electronic control module, and may update the target address to the fourth electronic control module. For the way of example but not limitation, when the CAN inspection message is scheduled to be delivered into a target electronic control module but could not be delivered into the target electronic control module for a predetermined time, the CAN inspection message is updated to be delivered into a next-target electronic control module.

In some forms of the present disclosure, the time allocated to each electronic control module or the predetermined time may be 10 ms, without being limited thereto. In this case, a time needed to confirm the operation states or faults of the plurality of electronic control modules embedded in the vehicle may be substantially identical to a time obtained when 10 ms is multiplied by the number of electronic control modules. However, the time allocated to each electronic control module or the predetermined time may be changed according to the processing system contained in the electronic control module, the operation environment of the CAN, and the performance of the vehicle diagnosis device.

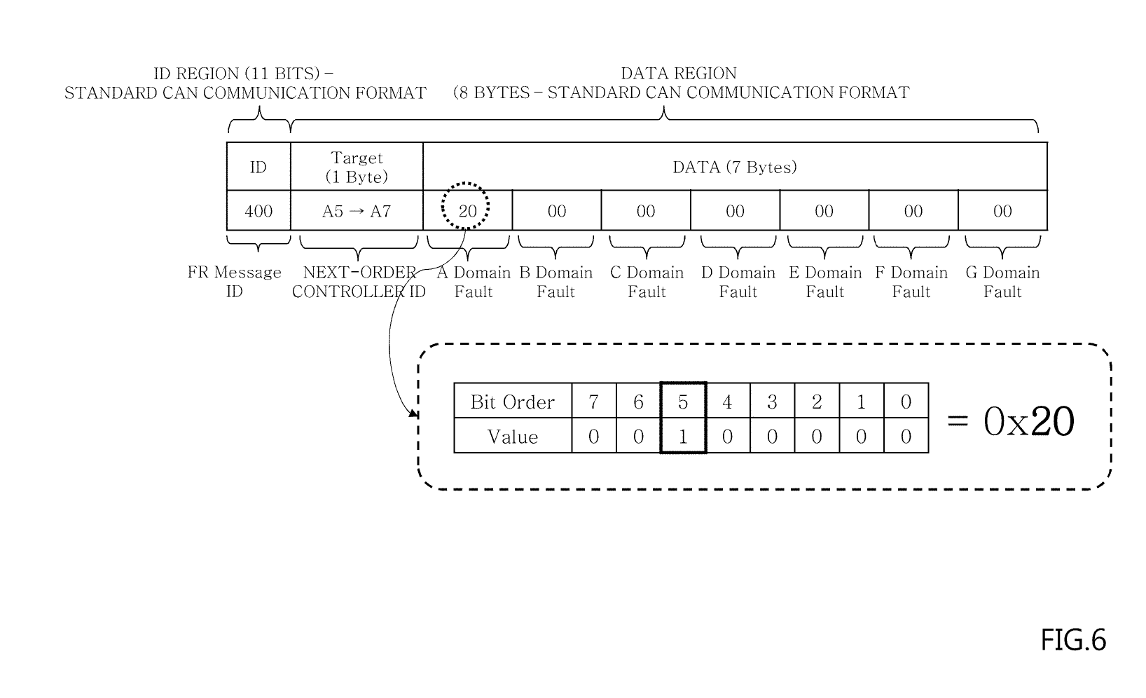

FIG. 6 is a conceptual diagram illustrating a fault record (FR) message. Referring to FIG. 6, the FR message may be substantially identical in format to the standard format message or the extended format message used in the CAN. However, although the standard format or the extended format is used, a specific region may be modified or used in a different way so as to confirm the operation states or faults of the plurality of electronic control modules. For convenience of description, a plurality of regions (i.e., SOF (Start Of Frame), RTR (Remote Transmission Request), SRR (Substitute Remote Request), IDE (Identifier Extension), R0, R1, etc.) contained in the standard format message or the extended format message used in the CAN will hereinafter be omitted.

As shown in FIG. 6, the FR message may use the ID region (11 bits) and the data region (8 bytes, 64 bits) based on the standard format. Although not shown in the drawings, even when the extended format is used, the ID region (29 bits) and the data region (8 bytes, 64 bits) may be used.

First of all, a specific ID (e.g., 400) to be used for the FR message may be allocated to the ID region (11 bits) based on the standard format. In this case, the ID value is only an example, and may be changeable according to manufacturing companies of vehicles or vehicle structures.

In some forms of the present disclosure, two different FR message IDs may be allocated by only one vehicle as necessary. This means that it is impossible to diagnose and inspect all the electronic control modules embedded in the vehicle using only one FR message. In addition, when a user desires to diagnose only some electronic control modules instead of all the electronic control modules using only one FR message, i.e., when the user desires to inspect the operation states or faults of electronic control modules contained in some parts of the domain or sub-group to which the plurality of electronic control modules is allocated, a target to be diagnosed may also be selected through another FR message having another ID information as necessary.

The CAN inspection message may have the data length of 8 bytes (64 bits). The first byte from among the 8 bytes may be used as a target address region indicating each electronic control module, and the second to eighth bytes (total of 7 bytes) from among the 8 bytes may correspond to electronic control modules allocated to respective domains or sub-groups. That is, the bits contained in the second to eighth bytes may respectively correspond to the electronic control modules contained in each sub-group. The values of the data region of the CAN inspection message may be displayed in hexadecimal. Since the respective bits of the data region correspond to the respective electronic control modules, although the values of the data region are displayed in hexadecimal, the respective values may not overlap with each other or may not be unclear.

Referring to FIG. 6, the inspection message may indicate an exemplary case in which, although the electronic control module having the address A4 sets the address A5 to the target address region and then transmits the resultant target address region having the address A5, the electronic control module having the address A6 receives the resultant target address region after lapse of a predetermined time. The target address region of the data region contained in the CAN inspection message may have the address A5, and the electronic control module having the address A6 may recognize that the value of the target address region of the inspection message is different from its own address value. Thereafter, the electronic control module having the address A6 may change the data value corresponding to the domain A to a data value ‘20’. In this case, the data value ‘20’ corresponding to the domain A may be obtained when the corresponding value is displayed in hexadecimal because the bit value corresponding to A5 is changed from ‘0’ to ‘1’. Thereafter, the electronic control module having the address A6 may change the value of the target address region to another address A7.

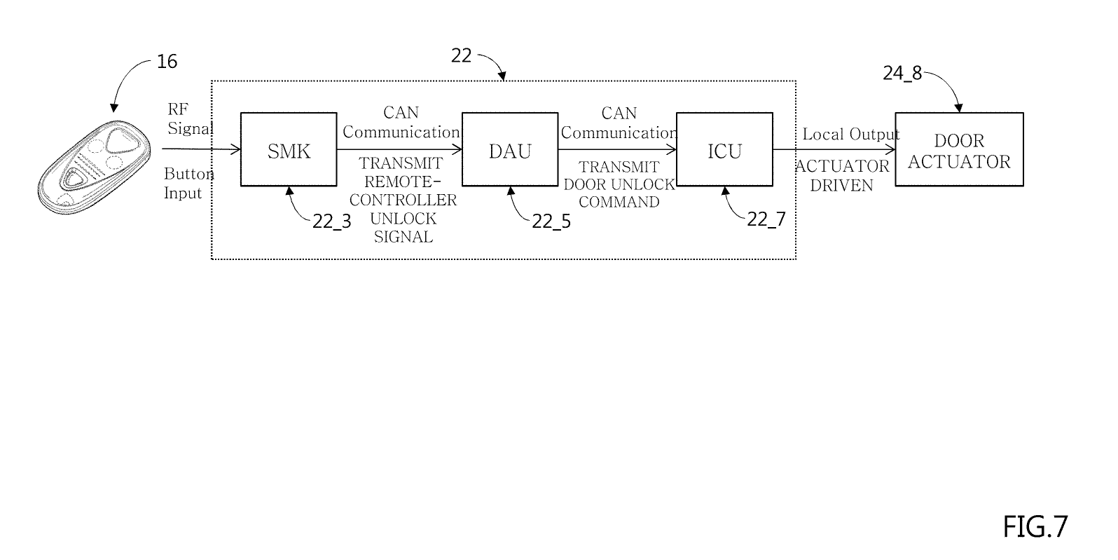

FIG. 7 is a conceptual diagram illustrating an example for diagnosing the plurality of electronic control modules embedded in the vehicle.

Referring to FIG. 7, the in-vehicle electronic control module 22 associated with the operation for locking/unlocking vehicle doors using a smart key 16 may include a smart key unit (SMK), a door area unit (DAU), an integrated control unit (ICU), etc. The in-vehicle electronic control module 22 associated with the operation for locking/unlocking vehicle doors may control a door actuator 24_8 acting as an in-vehicle device.

The number of electronic control modules 22 capable of being associated with the operation for locking/unlocking vehicle doors using the smart key (SMK) is a plural number. As a result, when the diagnosis method shown in FIGS. 1 to 6 is not used, the corresponding units must be inspected one by one. For example, there is a need for the diagnosis method to inspect whether an unexpected problem occurs in a communication process from the SMK to the DAU, as well as to inspect whether an unexpected problem occurs in a communication process from the DAU to the ICU.

However, if it is possible to simultaneously inspect the operation states or faults of the plurality of electronic control modules embedded in the vehicle through only one message according to the diagnosis method and apparatus shown in FIGS. 1 to 6, not only information regarding the presence or absence of a fault caused by a specific function of the vehicle, but also the operation states or faults of a region or function that is not easily recognized by the driver or user can be inspected.

As described above, the method and apparatus for detecting, diagnosing and checking the operation states or faults of the plurality of electronic control modules embedded in the vehicle in some forms of the present disclosure can reduce a time to be consumed for fault diagnosis or fault analysis. That is, within a predetermined time ranging from tens of milliseconds (ms) to hundreds of milliseconds (ms) after transmission of the FR message, it can be recognized which one of the fault control modules will be used. For example, assuming that the number of vehicle control modules is 30 and the time interval between messages is set to 10 ms, the fault detection time is about 30×10 ms=300 ms.

In addition, the method and apparatus for detecting, diagnosing or checking the operation states or faults of the plurality of electronic control modules embedded in the vehicle in some forms of the present disclosure need not define a message for each controller for the diagnosis function. That is, since all the control modules embedded in the vehicle can sequentially transmit only one message according to the token scheme, load of the bus may not be increased.

The method and apparatus for detecting, diagnosing or checking the operation states or faults of the plurality of electronic control modules embedded in the vehicle in some forms of the present disclosure can be flexibly applied according to vehicle network structures. That is, the space of 7 bytes from among the data region contained in the CAN message can be used to freely establish the FR position according to the number of domains (or sub-groups)/control modules.

As is apparent from the above description, the effects of the apparatus and method according to the disclosure are as follows.

The apparatus and method in some forms of the present disclosure can quickly recognize the operational state and fault diagnosis result of electronic control modules embedded in a vehicle using a single message over a CAN which acts as a vehicle communication network in the vehicle.

The present disclosure provides a fault diagnosing method which can flexibly apply to the vehicle in response to types of the electronic control modules embedded in the vehicle and the number of the electronic control modules, improving efficiency in maintenance and management of the vehicle.

In addition, the present disclosure may allow the vehicle to self-diagnose the operational state and fault of the electronic control modules embedded in the vehicle, such that a driver who rides in the vehicle can recognize the self-diagnosis result, improving vehicle driving safety.

The above-mentioned forms of the present disclosure may be implemented as code that can be written to a computer-readable recording medium and can thus be read by a computer. The computer-readable recording medium may be any type of recording device in which data can be stored in a computer-readable manner. Examples of the computer-readable recording medium include an HDD (Hard Disk Drive), an SSD (Solid State Drive), an SDD (Silicon Disc Drive), a ROM, a RAM, a CD-ROM, a magnetic tape, a floppy disk, optical data storage, and a carrier wave (e.g., data transmission over the Internet).

The recording media readable by the computer may be distributed to computer systems connected to each other through a network such that code readable by the computer is stored or executed in a distributed manner. In addition, a functional program, code, and code segments for embodying the above method may be easily reasoned by programmers in the art to which the disclosure pertains.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An apparatus for inspecting an electronic control module of a vehicle comprising:
a plurality of electronic control modules configured to control a device or system embedded in the vehicle; and
a Controller Area Network (CAN) configured to interconnect the plurality of electronic control modules,
wherein a single CAN inspection message is configured to check operation states or failures of the plurality of electronic control modules.

2. The apparatus of claim 1, wherein each electronic control module of the plurality of electronic control modules:
has an independent identifier (ID) or address; and
corresponds to a bit contained in the single CAN inspection message.

3. The apparatus of claim 1, wherein the single CAN inspection message is received by one of the plurality of electronic control modules, and transmitted to another of the plurality of electronic control modules, within a predetermined amount of time in sequence.

4. The apparatus of claim 3, wherein:
when a first electronic control module of the plurality of electronic control modules transmits the single CAN inspection message to a second electronic control module of the plurality of electronic control modules within a predetermined amount of time, the second electronic control module is configured to update a target address contained in the single CAN inspection message to a third electronic control module of the plurality of electronic control modules.

5. The apparatus of claim 3, wherein:
when a first electronic control module of the plurality of electronic control modules does not transmit the single CAN inspection message to a second electronic control module of the plurality of electronic control modules within the predetermined amount of time, but the first electronic module of the plurality of electronic control modules transmits the single CAN inspection message to the third electronic control module of the plurality of electronic control modules, a third electronic control module of the plurality of electronic control modules is configured to:
display a fault-state of the second electronic control module of the plurality of electronic control modules that is contained in the single CAN inspection message corresponding to the second electronic control module of the plurality of electronic control modules; and
update the target address to a fourth electronic control module of the plurality of electronic control modules.

6. The apparatus of claim 5, wherein:
the predetermined amount of time is 10 ms; and
an amount of time needed to inspect the operation state of the plurality of electronic control modules is substantially identical to an amount of time that is obtained by multiplying a number of the electronic control modules of the plurality of electronic control modules by 10 ms.

7. The apparatus of claim 1, wherein the plurality of electronic control modules comprises at least one sub-group, and each sub-group of the at least one sub-group comprises eight (8) electronic control modules or less.

8. The apparatus of claim 7, wherein:
the CAN inspection message has a data length of eight (8) bytes, wherein a first byte among the 8 bytes indicates the electronic control module and a second byte to an eighth byte among the 8 bytes indicate a sub-group of the at least one sub-group.

9. The apparatus of claim 8, wherein:
each bit contained in the second byte to the eighth byte corresponds to an electronic control module that is contained in each sub-group, and the CAN inspection message is displayed in hexadecimal.

10. The apparatus of claim 8, wherein the CAN inspection message comprises ID information that is based on a standard format or an extended format.

11. The apparatus of claim 10, wherein:
when the CAN inspection message checks the operation states of the electronic control modules that are contained in some parts of the sub-groups, the some parts of the sub-groups are designated through the ID information.

12. The apparatus of claim 1, wherein the apparatus further comprises:
an On Board Diagnostics (OBD) terminal configured to:
transmit the CAN inspection message to the plurality of electronic control modules; and
output to an external part the CAN inspection message including information regarding the operation states of the plurality of electronic control modules.

13. The apparatus according to claim 1, wherein the apparatus further comprises:
a self-diagnosis device configured to transmit and receive the CAN inspection message, wherein the self-diagnosis device is embedded in the vehicle; and
a communication device configured to transmit the information regarding the operation states of the plurality of electronic control modules that are detected by the self-diagnosis device.

14. A method for inspecting an electronic control module of a vehicle for use in an inspection apparatus the method comprising:
providing a single Controller Area Network (CAN) inspection message for checking operation states of a plurality of electronic control modules;
recording information regarding the operation states of the plurality of electronic control modules in the single CAN inspection message; and
checking the operation states of the plurality of electronic control modules through the single CAN inspection message,
wherein the CAN is configured to interconnect the plurality of electronic control modules such that the plurality of electronic control modules control a device or system embedded in the vehicle.

15. The method of claim 14, wherein each electronic control module of the plurality of electronic control modules:
has an independent identifier (ID) or address; and
corresponds to a bit contained in the single CAN inspection message.

16. The method of claim 15, wherein the method comprises:
sequentially transmitting and receiving, with the plurality of electronic control modules, the single CAN inspection message within a predetermined amount of time.

17. The method of claim 16, wherein:
when a first electronic control module of the plurality of electronic control modules transmits the single CAN inspection message to a second electronic control module of the plurality of electronic control modules within a predetermined amount of time, updating, with the second electronic control module of the plurality of electronic control modules, a target address contained in the single CAN inspection message to a third electronic control module of the plurality of electronic control modules; and
when the first electronic control module of the plurality of electronic control modules does not transmit the single CAN inspection message to the second electronic control module of the plurality of electronic control modules within the predetermined amount of time, but is the first electronic control module of the plurality of electronic control modules transmits the single CAN inspection message to the third electronic control module of the plurality of electronic control modules, displaying, with the third electronic control module of the plurality of electronic control modules, a fault-state of the second electronic control module of the plurality of electronic control modules that is contained in the single CAN inspection message corresponding to the second electronic control module of the plurality of electronic control modules, and updating the target address to a fourth electronic control module of the plurality of electronic control modules.

18. The method of claim 14, wherein:
the single CAN inspection message has a data length of eight (8) bytes, wherein a first byte among the 8 bytes indicates the electronic control module and a second byte to an eighth byte among the 8 bytes indicate a sub-group.

19. The method of claim 18, wherein the single CAN inspection message comprises
ID information that is based on a standard format or an extended format.

20. An apparatus for inspecting a vehicle comprising:
a collection unit configured to:
collect information of the vehicle through a cable connected to an On Board Diagnostics (OBD) terminal that is embedded in the vehicle; and
transmit and receive a single CAN inspection message such that the CAN inspection message checks the operation states of the plurality of electronic control modules; and
a processor configured to check operation states of the plurality of electronic control modules such that the plurality of electronic control modules control a device or system embedded in the vehicle, wherein a Controller Area Network (CAN) is configured to interconnect the plurality of electronic control module.
